(19) United States
(12) Patent Application Publication
(10) Pub. No.: US 2025/0122449 A1
(43) Pub. Date: Apr. 17, 2025

(54) Apparatus and method for producing beer wort from grain raw material

(71) Applicant: Chermen Mikhailovich KAITUKOV, Moscow (RU)

(72) Inventor: Chermen Mikhailovich KAITUKOV, Moscow (RU)

(21) Appl. No.: 18/765,708

(22) Filed: Jul. 8, 2024

(30) Foreign Application Priority Data
Oct. 11, 2023 (RU) 2023126060

(51) Int. Cl. C12C 7/06; C12C 7/04; C12C 7/16; C12C 7/17

(52) U.S. Cl. CPC C12C 7/065; C12C 7/042; C12C 7/163; C12C 7/17

(57) ABSTRACT

The invention is related to the food industry. The proposed apparatus is used for wort production from grain raw material, and comprises a lower tier, an upper tier and at least one process tier located in-between. Each tier is equipped with a mixer, a water supply pipe, a wort transfer pipe and an auger separator, comprising a perforated pipe or a slotted screen with an auger, squeezed grain raw material outlets, a wort discharge branch pipe, a thrust washer and a thrust spring inside. The bottom of each tier is inclined. A funnel for crushed grain raw material supply is provided on the process tier located above the lower tier. A wort outlet is provided in the lower tier. A method for producing wort from grain raw material is also disclosed. The group of inventions provides an increase in the yield of the finished product.

### CROSS-REFERENCES

This application claims priority to RU 2023126060, filed Oct. 11, 2023, incorporated herein by reference in its entirety.

### BACKGROUND OF THE INVENTION

### Field of the invention

Invention relates to food industry, namely brewing, distilling, and production of grain distillates, and can be used for wort production at brewing, distilling and grain distillate plants.

### Background of the related art

A beer wort production method known from the prior art consists in mashing (malt crushing), malt filtering, wort heating followed by hot wort clarification, whereby at least one of the processes is continuous, and implementation of this method is proposed using an apparatus consisting of at least a mashing device, a filtering device, a heating (boiling) and a clarification device, whereby at least one of the devices is designed to provide a continuous wort production process (US20100291261 A1, 18.11.2010).

An apparatus for beer wort cooling and sediment settling known from the prior art comprising a combination of a series of overlapping trays or plates in a housing equipped with a removable lid and containing a device for blowing sterilized air through wort and a device for removing sediment from trays or plates (GB 155847 A, 23.03.1922).

An apparatus for continuous beer wort production known from the prior art comprising a scale, a malt dispenser, an auger, a crusher, multi-tiered interconnected saccharification reactors in the form of cylindrical vessels with jackets, mixing devices and outlets, a device for separating liquid mash from thick mash, a filter, and wort boiling devices. The apparatus additionally comprises a dispenser, a crusher and a masher for unmalted raw material, interconnected in series and installed in parallel to corresponding malt mash apparatuses, a device for unmalted mash pressure boiling interconnected with the unmalted raw material masher and the first saccharification reactor and consisting of a tubular heat exchanger, a steam separator and a refrigerator, and a similar device for pressure boiling the thick portion of mixed mash, interconnected with the second saccharification reactor in the process flow, and with the device for liquid mash separation from thick mash, whereby the latter device is installed between the first and second reactors (SU 432727 A3, 15.06.1974).

A wort production method known from the prior art comprising the processes of mash production, saccharification and filtration to produce starting wort, whereby the raw material being mashed is placed in at least one water-permeable container (pouch), whereby mash production, saccharification and filtration to produce starting wort are performed in a mobile vessel pre-loaded with water-permeable containers (pouches) with the raw material being mashed (RU 2396313 C2, 10.08.2010).

A mono block for beer wort production known from the prior art comprising a conical-bottom vessel with heating capability, a water cooling jacket and a filtering sieve fitted inside the vessel in the form of two segments capable of fast removal via a tightly closing hatch in the upper part of the vessel, and a mixer, for instance, of a parallel type, and pipes. The vessel is vertically subdivided into two parts by two discs, whereby the upper disc is firmly attached using a bearing flange, and the lower disc is capable of rotating relative to the upper disc in the horizontal plane using a mobile pin installed in the upper part of a hollow mixer shaft. The mobile pin rotates the intermediate shaft with its base attached to the lower mobile disc supported by adjustment bolts fitted on the bearing edges of the lower disc. Semicircular holes are provided in the upper and lower discs, covering ⅖ of each disc's area. The flat sieves are attached to the upper disc. Water electric heaters are installed in the lower part of the vessel, and the upper part of the conical bottom is equipped with a wort whirling pipe (RU 2185430 C2, 20.07.2002).

The closest technical solution to the proposed group of inventions is a method for continuous beer wort production by mixing malt and unmalted raw material, mashing with an aqueous phase and saccharification of the raw material mixture, separating the solid phase from the liquid phase, washing spent grain with water and introducing hops. Hops are introduced at the stage of mixing malt and unmalted raw material. Water for washing spent grain is supplied by counterflow, the solid phase is separated from the liquid phase after washing spent grain, and the obtained liquid phase is used as a water phase in mashing and saccharification. For this, the liquid phase is supplied to the last stage by counterflow. The solution also comprises an apparatus for continuous beer wort production consisting of a mixer for malt and unmalted raw material, interconnected mashing and saccharification sections in the form of cylindrical chambers with heat-exchange jackets, combined mixers, inlets and outlets, a device for separating the solid phase from the liquid phase in the form of a tilted vessel with an auger fitted inside, and a spent grain washing section equipped with a decanter fitted upstream of the mashing section. The spent grain washing section is a cylindrical chamber with an auger attached along its axis, fitted upstream of the device for separating the solid phase from the liquid phase. The decanter and mashing, saccharification and spent grain washing sections are arranged in sequence coaxially with each other, whereby their geometric axis is inclined at an angle of 3-4° to the horizon in the direction of the spent grain discharge (SU 1079665 A1, 15.03.1984).

The main disadvantages of the technical solution known from the prior art are a low efficiency coefficient of the equipment used and technical complexity of invention embodiments, as well as a low end product yield.

### SUMMARY OF THE INVENTION

Accordingly, the present invention is related to an apparatus for producing wort from grain raw material, including a lower tier; an upper tier; and at least one process tier located in-between the lower tier and the upper tier. A bottom of each tier is inclined relative to a horizontal. Each tier including a mixer, a water supply pipe, a wort transfer pipe and an auger separator that comprises a perforated pipe or a slotted screen and an auger; each separator including a squeezed grain raw material outlet; each separator also including, inside the perforated pipe or the slotted screen (i) a wort discharge branch pipe, (ii) a thrust washer and (iii) a thrust spring. A grain raw material supply funnel is on the process tier and above the lower tier; and a wort outlet is in the lower tier.

Optionally, each tier includes a heating jacket. Optionally, the upper tier includes a float water supply valve. Optionally, the apparatus includes between 2 and 20 process tiers.

In another aspect, a method of producing wort from grain raw material, the method including supplying water to a lower tier, an upper tier and at least one process tier that is located in-between the lower tier and the upper tier, so that an inclined bottom of each tier is completely covered; supplying grain raw material via a funnel to the lower tier; mixing the grain raw material with water using the mixer to produce a mash; supplying the mash to an inclined auger separator located on the lower tier; transferring the mash along a perforated pipe or a slotted screen using the auger separator; compacting the mash in an upper section of the perforated pipe or the slotted screen to obtain the beer wort, wherein the mash moves generally upwards from a tier to a next tier above it, while the beer wort moves generally downwards from a tier to a next tier below it; discharging the beer wort from the auger separator to a next lower tier while supplying compacted grain raw material is supplied to a next upper tier; and discharging the mash that includes compacted grain raw material from the upper tier and outputting the beer wort from an outlet in the lower tier. Optionally, the mash is separated into beer wort and the grain raw material while being transferred.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and, together with the description, serve to explain the principles of the invention.

In the drawings:

FIGS. 1-4 show various views of the apparatus for producing wort from grain raw material.

FIG. 5 shows an auger separator.

### DETAILED DESCRIPTION OF EMBODIMENTS OF THE INVENTION

Reference will now be made in detail to the preferred embodiments of the present invention, examples of which are illustrated in the accompanying drawings.

The technical result achieved by the proposed combination of features of the invention group is aimed at increasing the yield and density of the end product.

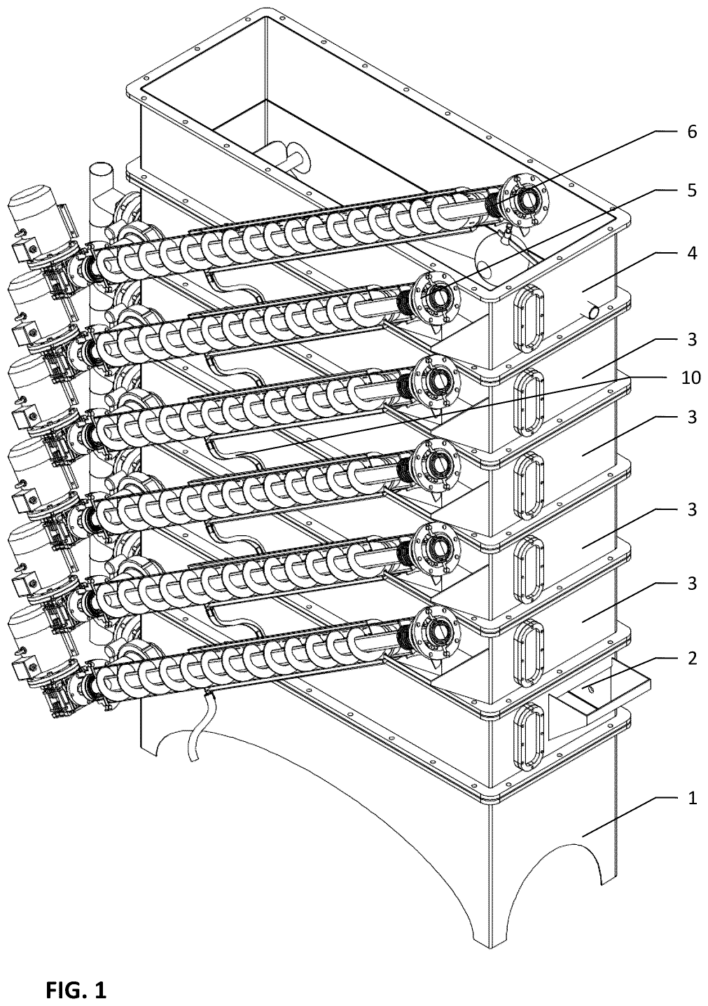

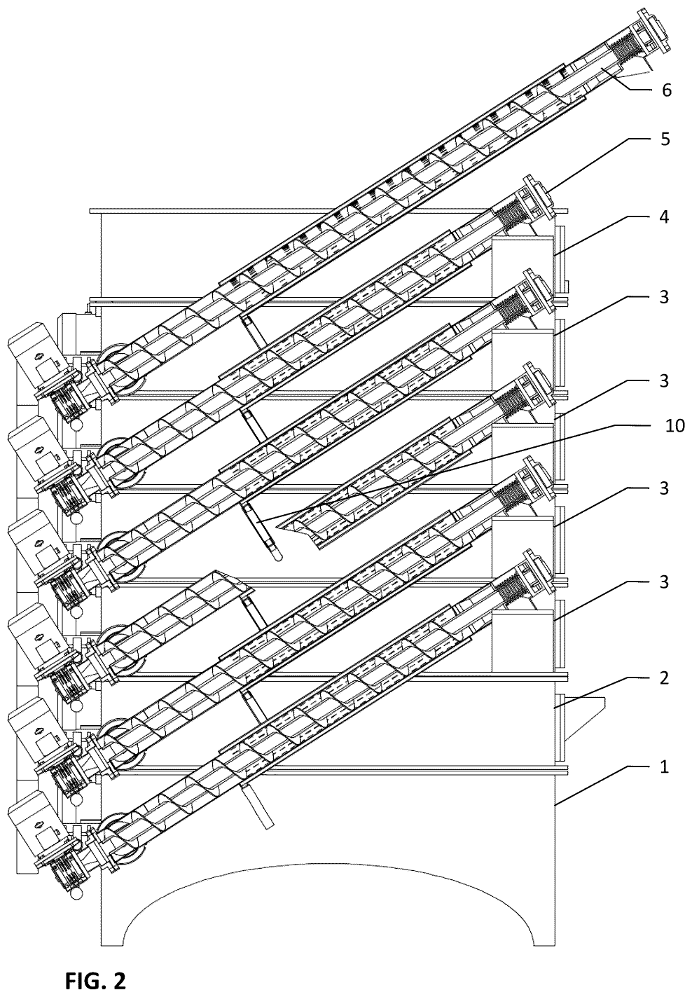

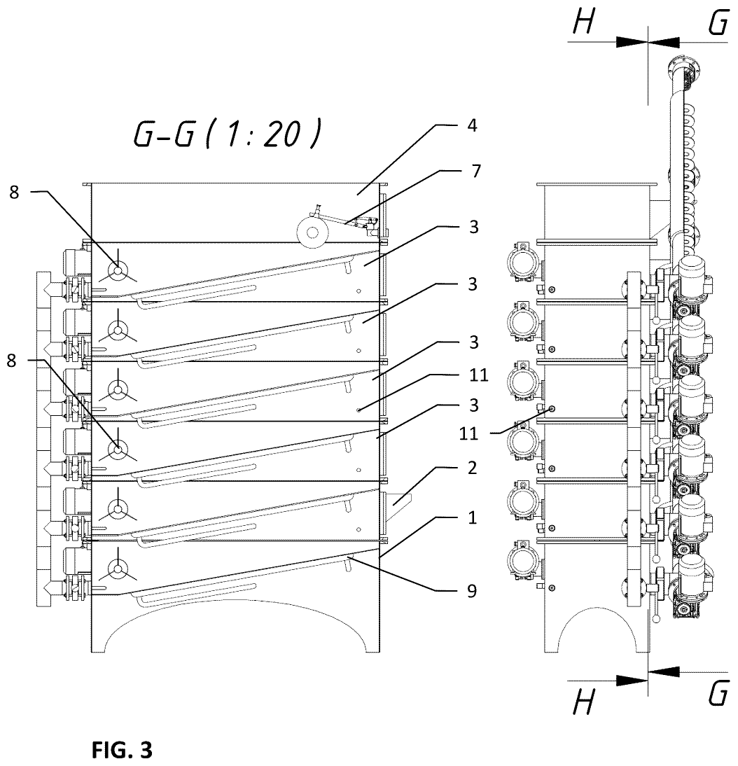

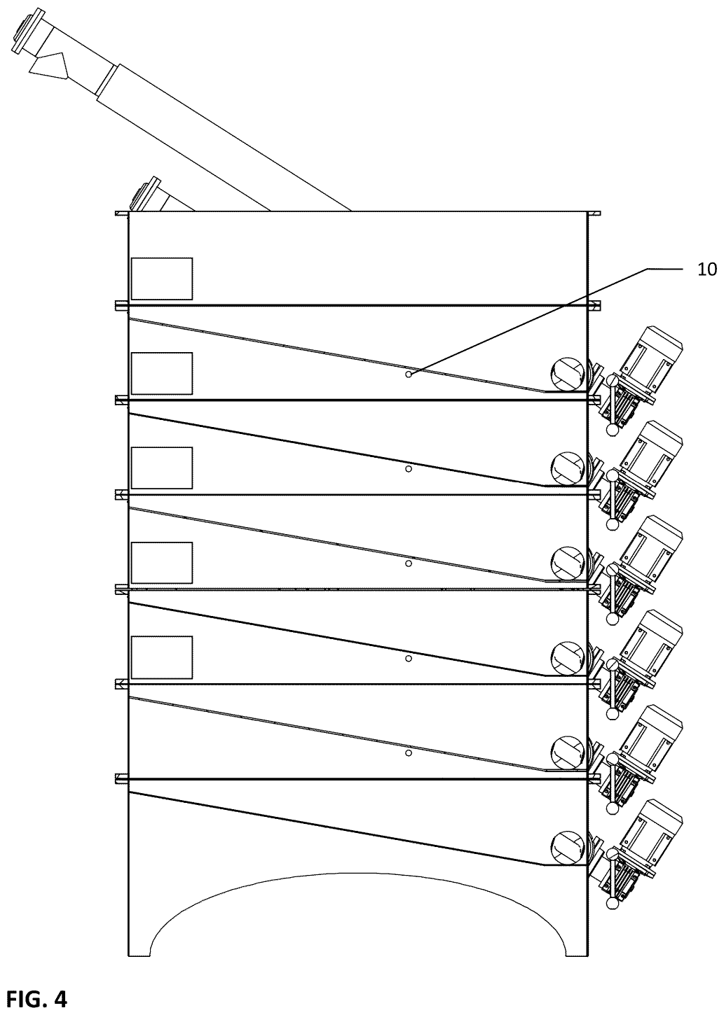

The apparatus for producing wort from grain raw material is shown in FIGS. 1-4, where the various elements are as follows:
1—lower tier,
2—grain raw material supply funnel,
3—process tier,
4—upper tier,
5—auger separator,
6—discharging auger separator,
7—valve for water supply to the upper tier,
8—mixer,
9—heating jacket,
10—wort transfer pipe,
11—water supply pipe,
12—auger separator auger,
13—perforated pipe or slotted screen,
14—thrust washer,
15—thrust spring,
16—squeezed grain raw material discharge outlet,
17—wort discharge pipe.

An apparatus for wort production from grain raw material, shown in FIGS. 1-4, proposed to achieve the technical result, includes a lower tier (1), an upper tier (4) and at least one process tier located in-between (3). Each tier is equipped with a mixer (8), a water supply pipe (11), a wort transfer pipe (10) and an auger separator (5), comprising a perforated pipe or a slotted screen (13) with an auger (12), squeezed grain raw material outlets (16), a wort discharge branch pipe (17), a thrust washer (14) and a thrust spring (15) inside. The bottom of each tier is inclined. Process tier (3) located above the lower tier (1) and includes a grain raw material supply funnel. The lower tier has a wort outlet.

Preferably, each tier is additionally equipped with a heating jacket (9). Preferably, a float water supply valve is installed on the upper tier (7). Preferably, the apparatus contains 1 to 20 process tiers (3).

To achieve the technical result, a method of producing wort from grain raw material using the aforesaid apparatus is also proposed. First, water is supplied to each apparatus tier to the level at which its inclined bottom is completely covered. The apparatus consists of a lower tier, an upper tier and at least one process tier located in-between. Each tier comprises a mixer, a water supply pipe, a wort transfer pipe and an auger separator, comprising a perforated pipe or a slotted screen with an auger, squeezed grain raw material outlets, a wort discharge branch pipe, a thrust washer and a thrust spring inside. The bottom of each tier is inclined. A funnel for grain raw material supply is provided on the process tier located above the lower tier. The lower tier comprises a wort outlet. Grain raw material is then supplied via the funnel to the lower tier, where it is mixed with water using the mixer. The mash obtained is supplied to an inclined auger separator located on the lower tier, where it is transferred along a perforated pipe or slotted screen using the auger, and compacted in their upper section. The wort obtained is discharged from the separator and supplied to the next lower process tier, and compacted grain raw material is supplied to the next upper process tier. Squeezed grain raw material is removed from the apparatus in the upper tier. Wort is removed via the outlet in the lower tier.

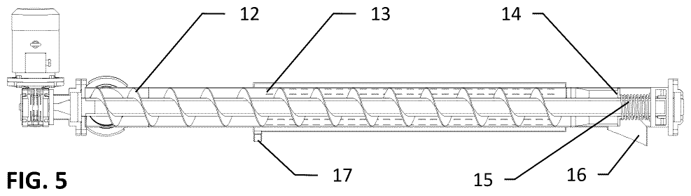

The auger separator is shown in FIG. 5.

The proposed apparatus for producing wort from grain raw material (FEBONIK) has the following operating principle.

At the first stage, water with a temperature of 20° C. to 80° C. is supplied via a water supply valve to the upper tier, to a level at which the inclined tier bottom is completely covered. Then the water level at the upper tier is maintained at target level, preferably using a float valve or level sensors. Water is supplied to the remaining process levels via supply pipes, also to the level at which the inclined tier bottom is completely covered. Then, grain raw material is supplied to the lower level via a crushed grain raw material supply funnel. For space saving purposes, the funnel is located on the side surface of the process tier located above the lower tier, where grain raw material is mixed with water using a mixer. Mash is continuously mixed on each tier using mixers provided on the tier. Mash is further supplied to an inclined auger separator, where it is transferred along a perforated pipe or slotted screen using an auger, and compacted in their upper section. The compaction process and its degree are adjusted using a thrust washer and thrust spring. Thereby, multiple squeezing of grain raw material is ensured. The wort obtained is discharged from the separator and supplied via a wort transfer pipe from the upper-tier separator to the lower tier until it reaches the lower tier and is discharged from the apparatus to a boiler. Compacted grain raw material is supplied to the upper tier, where mixing with water is repeated, and further separation is performed using an auger separator, which in this case is located on the subsequent higher level, until the material reaches the upper tier and is removed from the apparatus, i.e., wort is transferred from tier to tier downwards in the apparatus, and grain raw material is transferred from tier to tier upwards. Thereby, malt undergoes multiple separation and mixing with water or wort on the upper level.

There can be 1 to 20 process tiers depending on the material processing intensity required, and application field.

Each process tier can be equipped with a heating jacket used to maintain a specific temperature independently of the other tiers.

Due to the fact that grain raw material, when passing separation stages of the auger separator, is transferred from the bottom upwards, from the lower to the upper tier, releasing the required substances to the wort in the process, it depletes as it transfers along the tiers, contains a minimal amount of useful solubles in the upper tier, and only contains husk at the outlet of the upper discharging separator.

Conversely, wort undergoes transfer stages in reverse direction, i.e., from upper tiers to the lower tier, oppositely to grain raw material, becoming gradually more saturated with solubles, and is discharged from the lower tier with a maximum possible solids content, i.e., high density.

It is this opposite direction of grain raw material and wort flows that provides maximum yield from each kilogram of raw material used, high efficiency and performance of the system.

It should also be noted that the process modes of the proposed apparatus (FEBONIK) are easily adjustable, as the apparatus allows adjusting not only the temperature on each tier independently, but also the time of contact of grain raw material and wort by adjusting the rotation speed of auger separator's augers. Additionally, output density of finished wort is adjusted by increasing or decreasing the supply rate of crushed grain raw material to the lower tier.

Specific embodiments of the proposed apparatus for producing wort from grain raw material (FEBONIK) are discussed below, and it is easily noticeable for specialists that the embodiments are merely particular cases of the proposed apparatus.

### Embodiment 1

At the first stage, 5 kg of crushed malt is supplied to the lower tier via a funnel for supply of crushed grain raw material, e.g. malt. Also, 40 L of water is supplied to all tiers at the first stage. A temperature of 52° C. is set on the lower tier. Then, the mash is mixed for 2 minutes using a mixer, after which a separator working at 25 rpm removes all spent grain from the lower level within 3 minutes and transfers it to the next upper level, where the temperature is also 52° C. 20 L of wort obtained is supplied to a boiling device, and 20 L of wort remains on the lower level. A time of 2 minutes is set of the next level for mixing spent grain with water, after which a next-level separator is activated. In 3 minutes, the separator removes all spent grain from wort and transfers squeezed wort to the next level. The wort obtained on this level is transferred to the lower level where 20 L of wort is located. Then, 5 kg of raw material in the form of crushed malt is supplied to the first level again, and the process is restarted. Spent grain is transferred higher and higher using separators similarly to the first and second levels, with the only being that a temperature of 63° C. is set on the two upper levels, and a temperature of 72° C. is set on the next two levels. Wort is supplied lower and lower across the levels, transferring about 20 L to each lower level. On the topmost level, all wort previously supplied below is compensated using a float valve by maintaining a constant level of 40 L. After the last 6 th level, squeezed spent grain is collected in a hopper. The humidity obtained is below 60%, indicating a high efficiency of the proposed system. This way, 12 batches of malt, 5 kg each, are supplied. After passing the last 12th malt batch through the system, when it reaches the 6th level, prior to activation of the 6th-level separator, fresh water supply is terminated, and after squeezing of the last spent grain batch, i.e. when there is no more spent grain in the system, all separators are activated at increased speeds (100 rpm), all wort is supplied from all tiers to a lower tier, and then completely discharged from the first tier to the boiler.

The total raw material used is 60 kg, and over 420 L of wort with a density of 12% is obtained.

The duration of this experiment is 90 minutes from the first supply of crushed malt to the discharge of the last 12th batch of crushed malt in the form of squeezed spent grain from the upper level using the upper discharging separator.

### Embodiment 2

The process is similar to embodiment 1, except that 2-minute pauses are not used on each level for spent grain mixing and hydration, raw material is continuously suppled to an intake hopper at a rate of 60 kg for 30 minutes, and separators continuously operate at low speeds of 25 rpm. The last stage, at which all spent grain is discharged from the system, is completely identical to embodiment 1. All separators are activated at increased speeds of 100 rpm, and all wort is discharged to a boiler. As a result, all wort in the same amount of 420 L is collected in the boiler in the course of 50 minutes. However, a density reduction in the wort obtained to 11.8%, i.e. 0.2% below the results of the first series of experiments, is observed.

### Embodiment 3

The process is similar to embodiment 1, except for that 15 kg of crushed malt is initially suppled, the mixing time at each tier is 5 minutes, and the operation time of the auger separator is 5 minutes. As a result, 180 kg of crushed malt is used, and 400 L of wort with a density of 35% is obtained.

The duration of this experiment is 160 minutes.

The high yield of high-density wort obtained within such a short time period observed in the experiments confirm the high flexibility of the system as a whole and its extremely high efficiency.

### Embodiment 4

The process is similar to embodiment 1, except that grain raw material is a mixture of 30% malt and 70% wheat. Also, a temperature of 63° C. is maintained on all tiers. The goal is to obtain grain wort for further rectification or distillation, i.e. to produce alcohol or grain distillate.

As a result, 60 kg of grain raw material is used, including 18 kg of malt and 42 kg of wheat, and 420 L of wort with a density of 13% is obtained.

### Embodiment 5

The process is similar to embodiment 1, except that whiskey malt is used as raw material, and a temperature of 63° C. is maintained on all tiers. The goal is to obtain whiskey wort for further distillation.

As a result, 60 kg of whiskey malt is used, and 420 L of wort with a density of 11.8% is obtained.

Table 1 contains data confirming the advantages of the proposed group of inventions relative to the known technical solutions (the closest prior art being the Nessie system).

TABLE 1

| | | | FEBONIK | |
|---|---|---|---|---|
| | | | (proposed | |
| | Reference | | technical | |
| Indicator | value | Nessie | solution) | Comment |
| Humidity of spent | 80% | <80% | <60% | Multiple squeezing achieves a |
| grain | | | | humidity reduction, which |
| | | | | provides a reduction in extract |
| | | | | losses |
| Amount of wort | 6 L | 6.5 L | 7 L | Multiple counterflow washing |
| with a density of | | | | combined with multiple squeezing |
| 12% obtained from | | | | provide an increase in finished |
| each kilogram of | | | | product yield from each kilogram |
| crushed grain raw | | | | of raw material |
| material | | | | |
| Maximum possible | 18% | 25% | 35% | Significant increase in wort |
| density of obtained | | | | density as a result of using the |
| wort | | | | proposed apparatus |

The data of Table 1 suggests that the use of the presented group of inventions provides an increase in wort yield of grain raw material by reducing losses and increasing density.

Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

What is claimed is:

1. An apparatus for producing wort from grain raw material, comprising:
a lower tier;
an upper tier; and
at least one process tier located in-between the lower tier and the upper tier,
wherein a bottom of each tier is inclined relative to a horizontal;
each tier including a mixer, a water supply pipe, a wort transfer pipe and an auger separator that comprises a perforated pipe or a slotted screen and an auger;
each separator including a squeezed grain raw material outlet;
each separator also including, inside the perforated pipe or the slotted screen (i) a wort discharge branch pipe, (ii) a thrust washer and (iii) a thrust spring;
a grain raw material supply funnel on the process tier and above the lower tier; and
a wort outlet in the lower tier.

2. The apparatus of claim 1, wherein each tier includes a heating jacket.

3. The apparatus of claim 1, wherein the upper tier includes a float water supply valve.

4. The apparatus of claim 1, wherein the apparatus includes between 2 and 20 process tiers.

5. A method of producing wort from grain raw material, the method comprising:
supplying water to a lower tier, an upper tier and at least one process tier that is located in-between the lower tier and the upper tier, so that an inclined bottom of each tier is completely covered;
supplying grain raw material via a funnel to the lower tier;
mixing the grain raw material with water using the mixer to produce a mash;
supplying the mash to an inclined auger separator located on the lower tier;
transferring the mash along a perforated pipe or a slotted screen using the auger separator;
compacting the mash in an upper section of the perforated pipe or the slotted screen to obtain the beer wort,
wherein the mash moves generally upwards from a tier to a next tier above it, while the beer wort moves generally downwards from a tier to a next tier below it;
discharging the beer wort from the auger separator to a next lower tier while supplying compacted grain raw material is supplied to a next upper tier; and
discharging the mash that includes compacted grain raw material from the upper tier and outputting the beer wort from an outlet in the lower tier.

6. The method of claim 5, wherein the mash is separated into beer wort and the grain raw material while being transferred.
